(19) United States
(12) Patent Application Publication
(10) Pub. No.: US 2025/0196236 A1
(43) Pub. Date: Jun. 19, 2025

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventor: Hirokazu HATANO, Kyoto (JP)

(21) Appl. No.: 18/846,273

(22) PCT Filed: Mar. 8, 2023
(86) PCT No.: PCT/JP2023/008796

§ 371 Date: Sep. 12, 2024

(30) Foreign Application Priority Data
Mar. 15, 2022 (JP) 2022-040643

(51) Int. Cl. B23C 5/20

(52) U.S. Cl. CPC B23C 5/202; B23C 2200/0422

(57) ABSTRACT

A first outer region of an outer inclined surface of a cutting insert according to one aspect bas a width in a direction orthogonal to a first portion of a first side decreasing with distance from the first corner. A second outer region of the outer inclined surface bas a width in a direction orthogonal to a second portion of the first side increasing with distance from the first corner.

### TECHNICAL FIELD

The present disclosure relates to a cutting insert, a cutting tool, and a method for manufacturing a machined product.

### BACKGROUND OF INVENTION

A cutting insert disclosed in Patent Document 1 is known as a cutting insert applied to a cutting tool. The cutting insert described in Patent Document 1 includes a main cutting edge and a rake face extending from the main cutting edge. The rake face includes a portion having a linear shape (referred to as a land portion (6c) in Patent Document 1) and a portion having a protruding curved shape protruding in an upward direction (referred to as a main rake face (6a) in Patent Document 1) in a cross-sectional view. The portion having a linear shape is located along the main cutting edge, and the portion having a protruding curved shape is located on the inner side of the linear portion. The rake face has the portion having a protruding curved shape, and thus excessive contact of chips with the rake face can be avoided. Therefore, chip discharge performance is improved, and the progression of wear of the rake face is delayed, and thus wear resistance of the rake face can be improved.

### CITATION LIST

### Patent Literature

Patent Document 1: JP 2020-032498 A

### SUMMARY

A cutting insert according to an aspect of the present disclosure includes an upper surface, a lower surface located on an opposite side of the upper surface, a side surface connected to the upper surface and the lower surface, and
a cutting edge located at an intersection of the upper surface and the side surface. The upper surface includes a corner portion, a side portion connected to the corner portion and coming close to the lower surface with distance from the corner portion, an outer inclined surface extending along the side portion and tilting toward the lower surface with distance from the side portion, a middle inclined surface extending along the outer inclined surface and tilting toward the lower surface with distance from the outer inclined surface, an inner inclined surface extending along the middle inclined surface and tilting toward the lower surface with distance from the middle inclined surface, and a flat bottom surface connected to the inner inclined surface. In a cross-section taken along a direction parallel to an insert central axis passing through a center of the upper surface and a center of the lower surface, the outer inclined surface has a linear shape, and the middle inclined surface has a protruding curved shape protruding in an upward direction. The side portion includes a first portion connected to the corner portion, and a second portion connected to the first portion. The outer inclined surface includes: a first outer region extending along the first portion and having a width in a direction orthogonal to the first portion, the width decreasing with distance from the corner portion; and a second outer region extending along the second portion and having a width in a direction orthogonal to the second portion, the width increasing with distance from the corner portion. The middle inclined surface includes: a first middle region extending along the first outer region and having a width in the direction orthogonal to the first portion, the width increasing with distance from the corner portion; and a second middle region extending along the second outer region and having a width in the direction orthogonal to the second portion, the width decreasing with distance from the corner portion.

A cutting tool includes: a holder having a cylindrical shape extending from a first end to a second end along the rotation axis, the holder including a pocket located at a side of the first end; and
the cutting insert according to an aspect of the present disclosure, the cutting insert being located in the pocket.

A method for manufacturing a machined product according to an aspect of the present disclosure includes: rotating the cutting tool according to an aspect of the present disclosure; bringing the cutting tool, which is rotating, into contact with a workpiece; and separating the cutting tool from the workpiece.

### BRIEF DESCRIPTION OF THE DRAWINGS

FIG. 1 is a schematic perspective view of a cutting insert according to an embodiment of the present disclosure.

FIG. 2 is a schematic plan view of the cutting insert illustrated in FIG. 1.

FIG. 3 is a schematic side view of the cutting insert illustrated in FIG. 1.

FIG. 4 is an enlarged view of part IV in FIG. 2.

FIG. 5 is an enlarged cross-sectional view taken along line V-V in FIG. 4.

FIG. 6 is an enlarged cross-sectional view taken along line VI-VI in FIG. 4.

FIG. 7 is an enlarged cross-sectional view taken along line VII-VII in FIG. 4.

FIG. 8 is an enlarged cross-sectional view taken along line VIII-VIII in FIG. 4.

FIG. 9 is an enlarged cross-sectional view taken along line IX-IX in FIG. 4.

FIG. 10 is an enlarged cross-sectional view taken along line X-X in FIG. 2.

FIG. 11 is a schematic perspective view of a cutting tool according to an embodiment of the present disclosure.

FIG. 12 is a schematic perspective view of the cutting tool illustrated in FIG. 11 viewed at a different angle.

FIG. 13 is a schematic view illustrating a method for manufacturing a machined product according to an embodiment of the present disclosure.

FIG. 14 is a schematic view illustrating the method for manufacturing the machined product according to an embodiment of the present disclosure.

FIG. 15 is a schematic view illustrating the method for manufacturing the machined product according to an embodiment of the present disclosure.

### DESCRIPTION OF EMBODIMENTS

The portion having a linear shape of the rake face of the cutting insert described in Patent Document 1 extends monotonously along the entire main cutting edge. Therefore, if machining with a large cutting depth is performed, the portion having a linear shape of the rake face may excessively come into contact with chips. As a result, the chip discharge performance and the durability of the rake face are desired to be improved.

According to the present disclosure, chip discharge performance and wear resistance of an outer inclined surface that is a rake face can be improved.

A cutting insert, a cutting tool, and a method for manufacturing a machined product according to an embodiment of the present disclosure will be described below in detail with reference to the drawings. However, each of the drawings, which will be referred to below, is a simplified representation of only components necessary for description of the embodiment, for convenience of description. Accordingly, the cutting insert and the cutting tool according to an embodiment of the present disclosure may be provided with an optional component that is not illustrated in each of the referred drawings. The dimensions of the components in the drawings do not faithfully represent the actual dimensions of the components, the dimension ratios of the members, or the like.

In the present disclosure, the insert central axis refers to a virtual axis passing through the center of the upper surface of the cutting insert and the center of the lower surface of the cutting insert. The term “inward direction” or “inner side” refers to a direction toward or a side closer to the insert central axis in the cutting insert. The term “outward direction” or “outer side” refers to a direction or a side away from the insert central axis in the cutting insert. The term “orthogonal” is not limited to being strictly orthogonal and means that an error of approximately ±5 degrees is allowed. The term “parallel” is not limited to being strictly parallel and means that an error of about ±5 degrees is allowed.

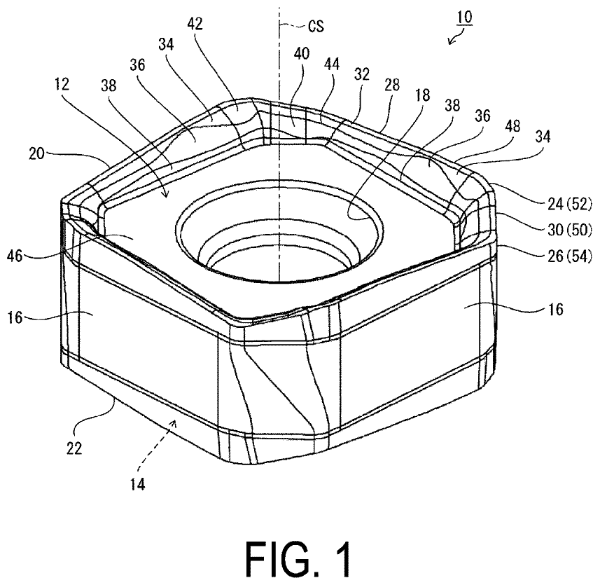

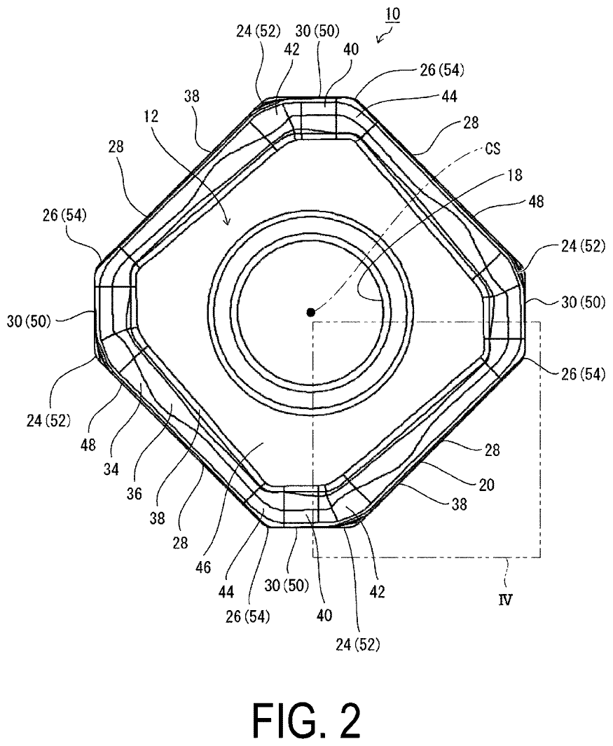

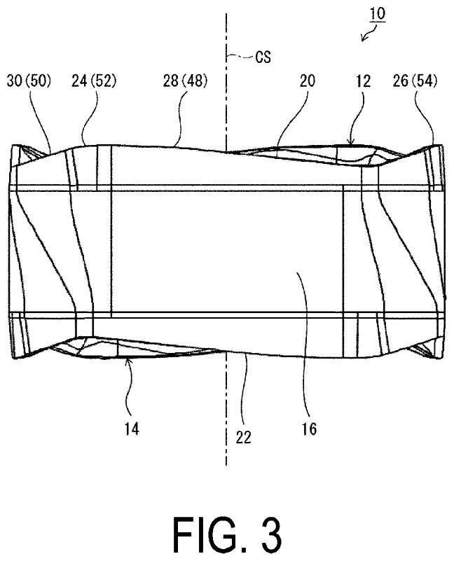

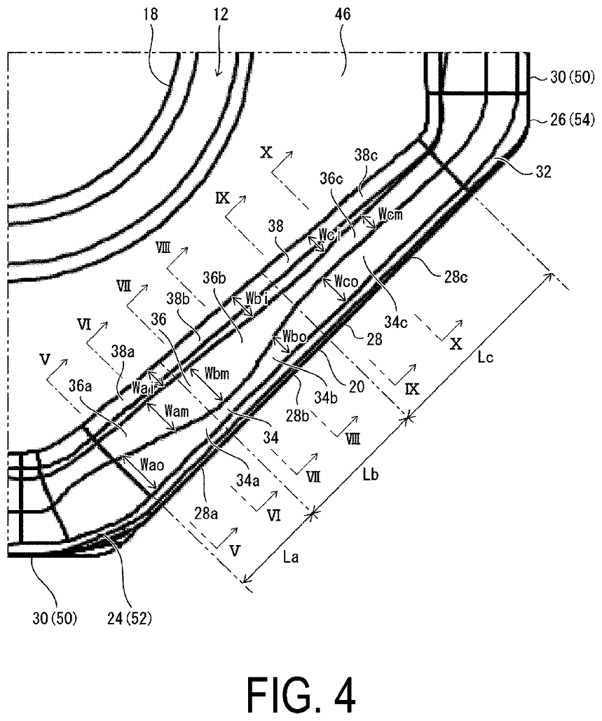

A cutting insert 10 according to an embodiment of the present disclosure will be described with reference to FIGS. 1 to 10. FIG. 1 is a schematic perspective view of the cutting insert 10 according to the embodiment of the present disclosure. FIG. 2 is a schematic plan view of the cutting insert 10 illustrated in FIG. 1. FIG. 3 is a schematic side view of the cutting insert 10 illustrated in FIG. 1. Note that FIG. 3 is a side view from a direction in which a first side described below is viewed from the front. FIG. 4 is an enlarged view of part IV in FIG. 2.

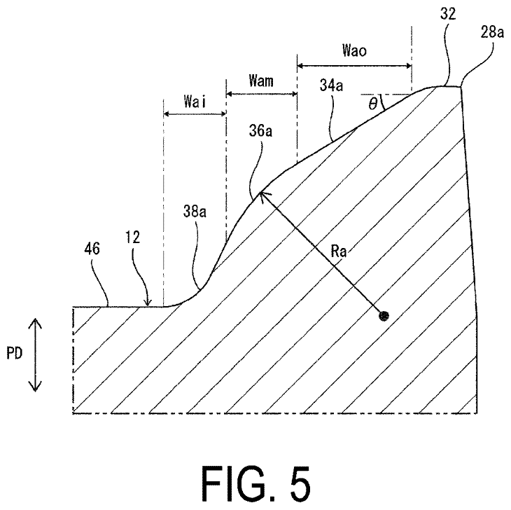

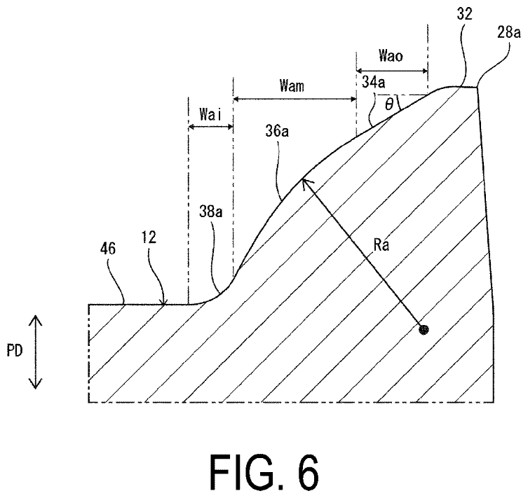

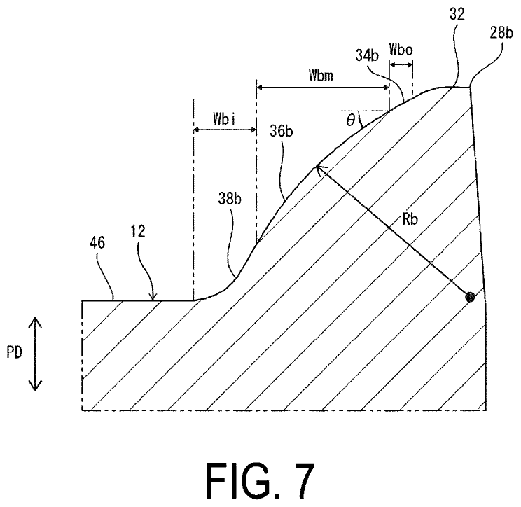

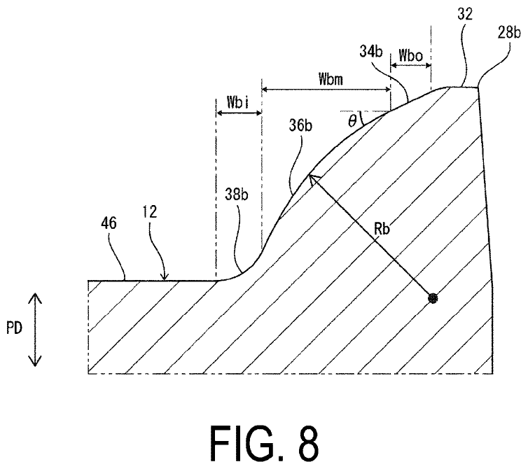

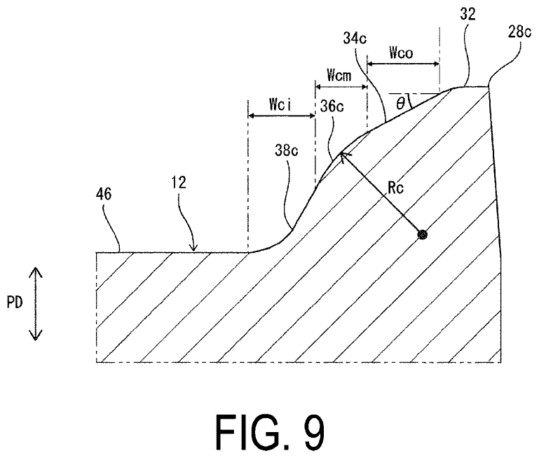

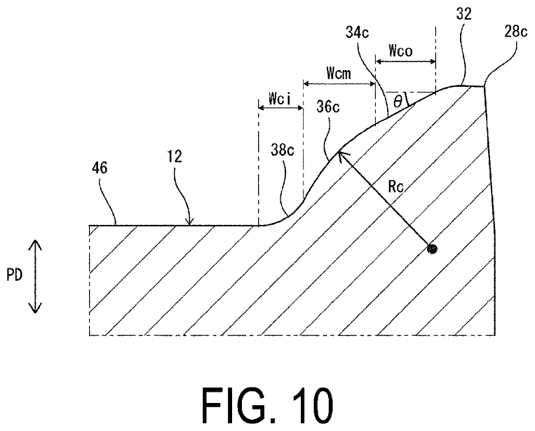

FIG. 5 is an enlarged cross-sectional view taken along line V-V in FIG. 4. FIG. 6 is an enlarged cross-sectional view taken along line VI-VI in FIG. 4. FIG. 7 is an enlarged cross-sectional view taken along line VII-VII in FIG. 4. FIG. 8 is an enlarged cross-sectional view taken along line VIII-VIII in FIG. 4. FIG. 9 is an enlarged cross-sectional view taken along line IX-IX in FIG. 4. FIG. 10 is an enlarged cross-sectional view taken along line X-X in FIG. 4.

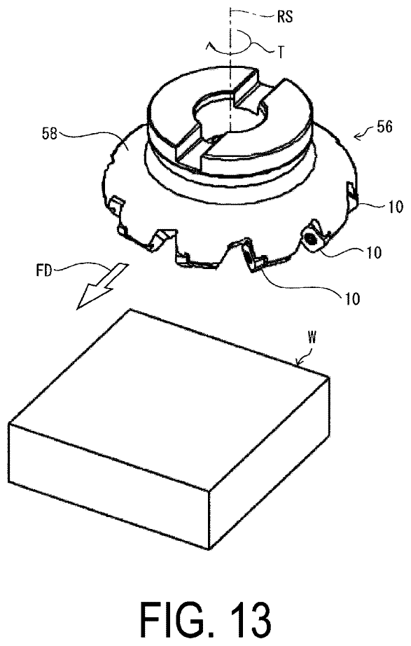

The cutting insert 10 according to the embodiment of the present disclosure is a component of a cutting tool used for machining (milling processing) of a workpiece W (see FIG. 13) made of a metal material or the like. Examples of the machining of the workpiece W include shoulder machining, grooving, R machining, profiling, and the like.

As in the examples illustrated in FIGS. 1 to 3, the cutting insert 10 may include an upper surface 12 and a lower surface 14 located on the opposite side of the upper surface 12. Each of the upper surface 12 and the lower surface 14 may have a polygonal shape, for example, an octagonal shape. In other words, the cutting insert 10 may have a polygonal plate shape, for example, an octagonal plate shape. Each of the upper surface 12 and the lower surface 14 may have a polygonal shape, for example, a triangular shape, a quadrangular shape, or the like other than the octagonal shape. In other words, the cutting insert 10 may have a polygonal plate shape, for example, a triangular plate shape, a quadrangular plate shape, or the like other than the octagonal plate shape. The polygonal shape is not limited strictly to a shape of a polygon.

As in the examples illustrated in FIGS. 1 and 2, each of the upper surface 12 and the lower surface 14 may have a rotationally symmetrical shape at a constant angle with respect to an insert central axis CS. The upper surface 12 and the lower surface 14 may be shaped such that the front and back sides are reversed and symmetrical. In other words, the cutting insert 10 may have a rotationally symmetrical shape at a constant angle with respect to the insert central axis CS, or may be shaped such that the front and back sides are reversed and symmetrical.

As in the examples illustrated in FIGS. 1 to 3, the cutting insert 10 may include a side surface 16 located between the upper surface 12 and the lower surface 14. The side surface 16 may be connected to the upper surface 12 and the lower surface 14. The side surface 16 may function as a flank face. The cutting insert 10 may include a mounting hole 18 penetrated from the upper surface 12 to the lower surface 14. One opening of the mounting hole 18 may be located in a central portion of the upper surface 12, and the other opening of the mounting hole 18 may be located in a central portion of the lower surface 14. The central axis of the mounting hole 18 may coincide with the insert central axis CS.

As in the examples illustrated in FIGS. 1 to 3, the cutting insert 10 may include a top cutting edge 20 and a bottom cutting edge 22. The top cutting edge 20 may be located at an intersection of the upper surface 12 and the side surface 16. The bottom cutting edge 22 may be located at an intersection of the lower surface 14 and the side surface 16. In other words, the cutting insert 10 may be a double-sided insert provided with the top cutting edge 20 and the bottom cutting edge 22. The top cutting edge 20 may be located at the entire intersection of the upper surface 12 and the side surface 16 or may be located at part of the intersection thereof. The bottom cutting edge 22 may be located at the entire intersection of the lower surface 14 and the side surface 16 or may be located at part of the intersection thereof.

As in the examples illustrated in FIGS. 1 and 2, the upper surface 12 formed in a polygonal shape may include a first corner 24 as a corner portion and a second corner 26 as another corner portion. Each of the first corner 24 and the second corner 26 may have a protruding curved shape protruding in an outward direction in a top view.

As in the examples illustrated in FIGS. 1 and 2, the upper surface 12 may include a first side 28 as a side portion connected to the first corner 24 and a second side 30 as another side portion connected to the first corner 24 on the opposite side of the first side 28. The second corner 26 may be connected to the second side 30 on the opposite side of the first corner 24. The first side 28 may have a linear shape in a top view, or may tilt toward the lower surface 14 with distance from the first corner 24 in a side view. The second side 30 may have a linear shape in a top view.

In a top view, the first side 28 and the second side 30 are not limited to the linear shape, and may have, for example, a gently protruding curved shape protruding in an outward direction. Here, “having a gently protruding curved shape” means having a radius of curvature larger than radii of curvature of the first corner 24 and the second corner 26 that have a protruding curved shape.

If the upper surface 12 has a rotationally symmetrical shape at a certain angle about the insert central axis CS, the upper surface 12 may have a plurality of the first corners 24 and a plurality of the second corners 26 as in the example illustrated in FIG. 2. In this case, the plurality of first corners 24 and the plurality of second corners 26 may be alternately located along the peripheral direction of the upper surface 12.

The upper surface 12 may also include a plurality of the first sides 28 and a plurality of the second sides 30. If the upper surface includes the plurality of first corners 24, the plurality of second corners 26, the plurality of first sides 28, and the plurality of second sides 30, the following description will be made by focusing on portions extracted one by one from these portions such that the aforementioned positional relationship is provided.

As in the examples illustrated in FIGS. 1 and 2, the upper surface 12 may include a land portion 32 located at the peripheral edge portion thereof, and the land portion 32 may be connected to the top cutting edge 20. The land portion 32 may function to enhance edge strength of the top cutting edge 20. The land portion 32 may be a portion that is adjacent to the top cutting edge 20 and is indicated by a straight line in a cross-section orthogonal to the top cutting edge 20 in a top view.

As in the examples illustrated in FIGS. 1 and 4 to 10, the upper surface 12 may include an outer inclined surface 34 extending along the first side 28 as a side portion, and the outer inclined surface 34 may be connected to the land portion 32 and inclined with respect to the land portion 32. The outer inclined surface 34 may tilt toward the lower surface 14 with distance from the first side 28. The outer inclined surface 34 may have a linear shape in a cross-section taken along a direction PD parallel to the insert central axis CS (see FIGS. 5 to 10). The outer inclined surface 34 may function as a rake face. An inclination angle θ of the outer inclined surface 34 with respect to a direction orthogonal to the direction PD parallel to the insert central axis CS may decrease with distance from the first corner 24.

As in the examples illustrated in FIGS. 4 to 10, the upper surface 12 may include a middle inclined surface 36 extending along the outer inclined surface 34, and the middle inclined surface 36 may be connected to the outer inclined surface 34. The middle inclined surface 36 may have a protruding curved shape protruding in an upward direction in the cross-section taken along the direction PD parallel to the insert central axis CS. The middle inclined surface 36 may have an arc shape that is one of protruding curved shapes in the cross-section taken along the direction PD parallel to the insert central axis CS. The middle inclined surface 36 may function as a rake face.

As in the examples illustrated in FIGS. 1 and 4 to 10, the upper surface 12 may include an inner inclined surface 38 extending along the middle inclined surface 36, and the inner inclined surface 38 may be connected to the middle inclined surface 36. The inner inclined surface 38 may tilt toward the lower surface 14 with distance from the middle inclined surface 36. The inner inclined surface 38 may have a recessed curved shape recessed downward in the cross-section taken along the direction PD parallel to the insert central axis CS. The inner inclined surface 38 may function as a rake face.

As in the examples illustrated in FIGS. 1 and 2, the upper surface 12 may include a minor inclined surface 40 extending along the second side 30, and the minor inclined surface 40 may be connected to the land portion 32 and inclined with respect to the land portion 32. The minor inclined surface 40 may tilt toward the lower surface 14 with distance from the second side 30. The minor inclined surface 40 may function as a rake face.

As in the examples illustrated in FIGS. 1 and 2, the upper surface 12 may include a first corner inclined surface 42 located on the inner side of the first corner 24. The first corner inclined surface 42 may be connected to the land portion 32, the outer inclined surface 34, the middle inclined surface 36, the inner inclined surface 38, and the minor inclined surface 40. The first corner inclined surface 42 may tilt toward the lower surface 14 with distance from the first corner 24. The first corner inclined surface 42 may function as a rake face.

As in the examples illustrated in FIGS. 1 and 2, the upper surface 12 may have a second corner inclined surface 44 located on the inner side of the second corner 26. The second corner inclined surface 44 may be connected to the land portion 32 and the minor inclined surface 40. The second corner inclined surface 44 may tilt toward the lower surface 14 with distance from the second corner 26. The second corner inclined surface 44 may function as a rake face.

As in the examples illustrated in FIGS. 1 and 2, the upper surface 12 may include a flat bottom surface 46 surrounding the opening of the mounting hole 18, and the bottom surface 46 may be orthogonal to the insert central axis CS. The bottom surface 46 may be connected to the inner inclined surface 38, the minor inclined surface 40, the first corner inclined surface 42, and the second corner inclined surface 44.

As illustrated in the examples illustrated in FIGS. 1 to 3, the top cutting edge 20 may include a main cutting edge 48 located on the first side 28. The main cutting edge 48 is a portion that can function as a main cutting edge in machining the workpiece W. The main cutting edge 48 may be located over the first side 28 or may be located over a portion of the first side 28. The main cutting edge 48 may have a linear shape in a top view.

As in the examples illustrated in FIGS. 1 to 3, the top cutting edge 20 may include a minor cutting edge 50 located on the second side 30. The minor cutting edge 50 may function as a flat cutting edge for finishing the machined surface of the workpiece W. The minor cutting edge 50 may be located over the second side 30 or may be located over a portion of the second side 30. The minor cutting edge 50 may have a linear shape in a top view.

As in the examples illustrated in FIGS. 1 and 2, the top cutting edge 20 may include a first corner edge 52 located on the first corner 24, and the first corner edge 52 may be connected to the main cutting edge 48 and the minor cutting edge 50. The first corner edge 52 may have a protruding curved shape protruding in an outward direction in a top view. The top cutting edge 20 may also include a second corner edge 54 located on the second corner 26, and the second corner edge 54 may be connected to the minor cutting edge 50. The second corner edge 54 may have a protruding curved shape protruding in an outward direction in a top view.

As in the example illustrated in FIG. 4, the first side 28 as the side portion may include a first portion 28a connected to the first corner 24 as the corner portion, a second portion 28b connected to the first portion 28a, and a third portion 28c connected to the second portion 28b. In the first side 28, a length Lb of the second portion 28b may be greater than a length La of the first portion 28a. In the first side 28, a length Lc of the third portion 28c may be greater than the length La of the first portion 28a and the length Lb of the second portion 28b.

As in the example illustrated in FIG. 4, the outer inclined surface 34 may include a first outer region 34a extending along the first portion 28a of the first side 28. In the first outer region 34a of the outer inclined surface 34, a width Wao in a direction orthogonal to the first portion 28a of the first side 28 may decrease with distance from the first corner 24. The outer inclined surface 34 may include a second outer region 34b extending along the second portion 28b of the first side 28. In the second outer region 34b of the outer inclined surface 34, a width Wbo in a direction orthogonal to the second portion 28b of the first side 28 may increase with distance from the first corner 24. The outer inclined surface 34 may include a third outer region 34c extending along the third portion 28c of the first side 28. In the third outer region 34c of the outer inclined surface 34, a width Wco in a direction orthogonal to the third portion 28c of the first side 28 may decrease with distance from the first corner 24.

As in the example illustrated in FIG. 4, the middle inclined surface 36 may include a first middle region 36a extending along the first outer region 34a of the outer inclined surface 34. In the first middle region 36a of the middle inclined surface 36, a width Wam in the direction orthogonal to the first portion 28a of the first side 28 may increase with distance from the first corner 24. The middle inclined surface 36 may include a second middle region 36b extending along the second outer region 34b of the outer inclined surface 34. In the second middle region 36b of the middle inclined surface 36, a width Wbm in the direction orthogonal to the second portion 28b of the first side 28 may decrease with distance from the first corner 24. The middle inclined surface 36 may include a third middle region 36c extending along the third outer region 34c of the outer inclined surface 34. In the third middle region 36c of the middle inclined surface 36, a width Wem in the direction orthogonal to the third portion 28c of the first side 28 may increase with distance from the first corner 24.

As in the examples illustrated in FIGS. 5 and 6, in the first middle region 36a of the middle inclined surface 36, a radius of curvature Ra of the first middle region 36a in the cross-section taken along the direction PD parallel to the insert central axis CS may increase with distance from the first corner 24. In other words, in the first middle region 36a of the middle inclined surface 36, the curvature radius of the first middle region 36a in the cross-section taken along the direction PD parallel to the insert central axis CS may be configured to decrease with distance from the first corner 24.

As in the examples illustrated in FIGS. 7 and 8, in the second middle region 36b of the middle inclined surface 36, a radius of curvature Rb of the second middle region 36b in the cross-section taken along the direction PD parallel to the insert central axis CS may decrease with distance from the first corner 24. As in the examples illustrated in FIGS. 9 and 10, in the third middle region 36c of the middle inclined surface 36, a radius of curvature Rc of the third middle region 36c in the cross-section taken along the direction PD parallel to the insert central axis CS may increase with distance from the first corner 24.

As in the examples illustrated in FIGS. 4 to 10, the inner inclined surface 38 may include a first inner region 38a extending along the first middle region 36a of the middle inclined surface 36. In the first inner region 38a of the inner inclined surface 38, a width Wai in the direction orthogonal to the first portion 28a of the first side 28 may decrease with distance from the first corner 24. The inner inclined surface 38 may include a second inner region 38b extending along the second middle region 36b of the middle inclined surface 36. The second inner region 38b of the inner inclined surface 38 may have a width Wbi in the direction orthogonal to the second portion 28b of the first side 28 increasing with distance from the first corner 24. The inner inclined surface 38 may include a third inner region 38c extending along the third middle region 36c of the middle inclined surface 36. In the third inner region 38c of the inner inclined surface 38, a width Wci in the direction orthogonal to the first portion 28a of the first side 28 may decrease with distance from the first corner 24.

As in the examples illustrated in FIGS. 1 to 3, if the upper surface 12 and the lower surface 14 are shaped such that the front and back sides are reversed and symmetrical, the lower surface 14 may include portions corresponding to the first corner 24, the second corner 26, the first side 28, the second side 30, the land portion 32, the outer inclined surface 34, the middle inclined surface 36, the inner inclined surface 38, the minor inclined surface 40, the first corner inclined surface 42, and the second corner inclined surface 44 of the upper surface 12. The configurations of the portions of the lower surface 14, which correspond to the first corner 24, the second corner 26, the first side 28, the second side 30, and the like may be the same as and/or similar to the configurations of the first corner 24, the second corner 26, the first side 28, the second side 30, and the like of the upper surface 12 except that the positional relationship in the vertical direction is reversed.

As in the examples illustrated in FIGS. 1 to 3, if the upper surface 12 and the lower surface 14 are shaped such that the front and back sides are reversed and symmetrical, the bottom cutting edge 22 may include portions corresponding to the main cutting edge 48, the minor cutting edge 50, the first corner edge 52, and the second corner edge 54 of the top cutting edge 20. The configurations of the portions of the bottom cutting edge 22, which correspond to the main cutting edge 48, the minor cutting edge 50, the first corner edge 52, and the second corner edge 54 may be the same as and/or similar to the configurations of the main cutting edge 48, the minor cutting edge 50, the first corner edge 52, and the second corner edge 54 of the top cutting edge 20 except that the positional relationship in the vertical direction is reversed.

An example of the material of the cutting insert 10 includes a cemented carbide alloy or a cermet. Examples of the composition of the cemented carbide alloy include WC-Co produced by adding a cobalt (Co) powder to tungsten carbide (WC) and sintering the mixture, WC-TiC-Co formed by adding titanium carbide (TiC) to WC-Co, or WC-TiC-TaC-Co formed by adding tantalum carbide (TaC) to WC-TiC-Co. The cermet is a sintered composite material obtained by combining a metal with a ceramic component and specific examples thereof include titanium compounds in which a titanium compound such as titanium carbide (TIC) or titanium nitride (TiN) is the main component.

The surface of the cutting insert 10 may be coated with a coating film using a chemical vapor deposition (CVD) method or a physical vapor deposition (PVD) method. Examples of the composition of the coating film include titanium carbide (TiC), titanium nitride (TiN), titanium carbonitride (TiCN), and alumina (Al₂O₃).

As in the example illustrated in FIG. 4, in the first outer region 34a of the outer inclined surface 34, the width Wao in the direction orthogonal to the first portion 28a of the first side 28 decreases with distance from the first corner 24. In the second outer region 34b of the outer inclined surface 34, the width Wbo in the direction orthogonal to the second portion 28b of the first side 28 increases with distance from the first corner 24. Therefore, the width of the outer inclined surface 34 changes in the order of a wide width, a narrow width, and a wide width from the first corner 24 side. In other words, a wide portion, a narrow portion, and a wide portion are disposed on the outer inclined surface 34 in this order from the first corner 24 side.

Accordingly, if machining with a small cutting depth or machining with a medium cutting depth is performed, the flow of chips can be controlled and stabilized by the wide portion of the outer inclined surface 34. If machining with a large cutting depth is performed, the chips easily separate from the narrow portion of the outer inclined surface 34, and the outer inclined surface 34 can be avoided from excessively coming into contact with the chips. If cutting with a large cutting depth is performed, chips are supported by the two wide portions of the outer inclined surface 34, and the flow of the chips can be stabilized. Therefore, according to the example of the embodiment of the present disclosure, chip discharge performance is improved, and the progression of wear of the outer inclined surface 34 is delayed. As a result, the wear resistance of the outer inclined surface 34 that is a rake surface can be improved.

In the first middle region 36a of the middle inclined surface 36, the width Wam in the direction orthogonal to the first portion 28a of the first side 28 increases with distance from the first corner 24. In the second middle region 36b of the middle inclined surface 36, the width Wbm in the direction orthogonal to the second portion 28b of the first side 28 decreases with distance from the first corner 24.

Therefore, the width of the middle inclined surface 36 changes in the order of a narrow width, a wide width, and a narrow width from the first corner 24 side in accordance with the change in the width of the outer inclined surface 34. In other words, in the middle inclined surface 36, a narrow portion, a wide portion, and a narrow portion are disposed in this order from the first corner 24 side. Accordingly, the thickness of a portion near the narrow portion of the outer inclined surface 34 is easily ensured. Consequently, according to the example of the embodiment of the present disclosure, damage such as chipping is less likely to occur in the top cutting edge 20, and the durability of the cutting insert 10 can be improved.

The radius of curvature Ra of the first middle region 36a of the middle inclined surface 36 may increase as a distance of the first middle region 36a from the first corner 24 increases. If machining with a small cutting depth or machining with a medium cutting is performed, the flow of chips can be controlled and stabilized by the first middle region 36a of the middle inclined surface 36.

The radius of curvature Rb of the second middle region 36b of the middle inclined surface 36 may decrease as a distance of the second middle region 36b from the first corner 24 increases. If cutting with a large cutting depth is performed, chips can be easily avoided from excessively coming into contact with the outer inclined surface 34.

The inclination angle θ of the outer inclined surface 34 may decrease as a distance of the outer inclined surface 34 from the first corner 24 increases. If machining with a large cutting depth is performed, chips are supported by the two wide portions of the outer inclined surface 34, and the flow of the chips can be stabilized.

In the first side 28, the length Lb of the second portion 28b may be greater than the length La of the first portion 28a. The boundary between the first portion 28a and the second portion 28b in the first side 28 can be disposed close to the first corner 24. In other words, the boundary between the first outer region 34a and the second outer region 34b and the boundary between the first middle region 36a and the second middle region 36b can be disposed close to the first corner 24. Therefore, even in machining with a relatively small cutting depth, chip discharge performance, the wear resistance of the outer inclined surface 34, and the durability of the cutting insert 10 can be improved.

In the first inner region 38a of the inner inclined surface 38, the width Wai in the direction orthogonal to the first portion 28a of the first side 28 may decrease with distance from the first corner 24. The second inner region 38b of the inner inclined surface 38 may have the width Wbi in the direction orthogonal to the second portion 28b of the first side 28 increasing with distance from the first corner 24.

In this case, the width Wam of the first middle region 36a tends to increase with distance from the first corner 24. In other words, the design flexibility with respect to changes in the width Wam of the first middle region 36a is high. The width Wbm of the second middle region 36b tends to decrease with distance from the first corners 24. In other words, the design flexibility with respect to changes in the width Wbm of the second middle region 36b is high. The width of the middle inclined surface 36 in the direction orthogonal to the first portion 28a at the boundary between the first middle region 36a and the second middle region 36b can be increased while avoiding an excessive increase in the distance from the boundary between the first portion 28a and the second portion 28b of the first side 28 to the bottom surface 46.

In the third outer region 34c of the outer inclined surface 34, the width Wco in the direction orthogonal to the third portion 28c of the first side 28 may decrease with distance from the first corner 24. In the third middle region 36c of the middle inclined surface 36, the width Wcm in the direction orthogonal to the third portion 28c of the first side 28 may increase with distance from the first corner 24.

If the third outer region 34c is configured as described above, the outer inclined surface 34 can be avoided from excessively coming into contact with chips. If the third portion 28c of the first side 28 is used as a part of the main cutting edge 48, the cutting depth is very large, and chips are likely to come into contact with a wide range of the outer inclined surface 34. However, the contact area of the chips in the third outer region 34c can be small, and thus excessive contact with the chips can be avoided as described above. The width Wco of the entire third outer region 34c is not narrow, but the width Wco decreases with distance from the first corner 24. Therefore, the chips are supported by the two wide portions of the outer inclined surface 34, and the function of stabilizing the flow of chips is easily maintained.

If the third middle region 36c is configured as described above, the thickness of the main cutting edge 48 at a location near the narrow portion of the third outer region 34c is easily ensured. Consequently, according to the example of the embodiment of the present disclosure, damage such as chipping is less likely to occur in the top cutting edge 20, and the durability of the cutting insert 10 can be improved.

The radius of curvature Rc of the third middle region 36c of the middle inclined surface 36 may increase as a distance of the third middle region 36c from the first corner 24 increases. If the third middle region 36c is configured as described above, the thickness of the main cutting edge 48 at a location near the narrow portion of the third outer region 34c is more easily ensured. Therefore, according to the example of the embodiment of the present disclosure, damage such as chipping is less likely to occur in the top cutting edge 20, and the durability of the cutting insert 10 can be improved.

The third portion 28c of the first side 28 may be greater than the first portion 28a and the second portion 28b. The two wide portions of the outer inclined surface 34 are unlikely to be located excessively away from the first corner 24. Therefore, even in machining with a relatively small cutting depth, the chips are supported by the two wide portions of the outer inclined surface 34, and the function of stabilizing the flow of chips is easily maintained.

### Cutting Tool

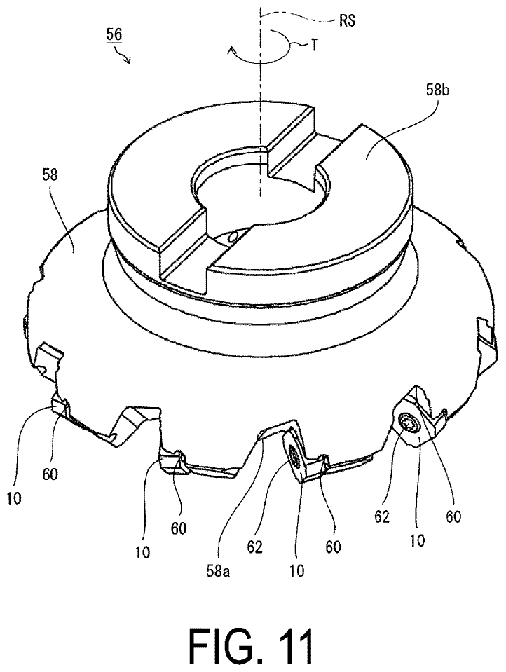

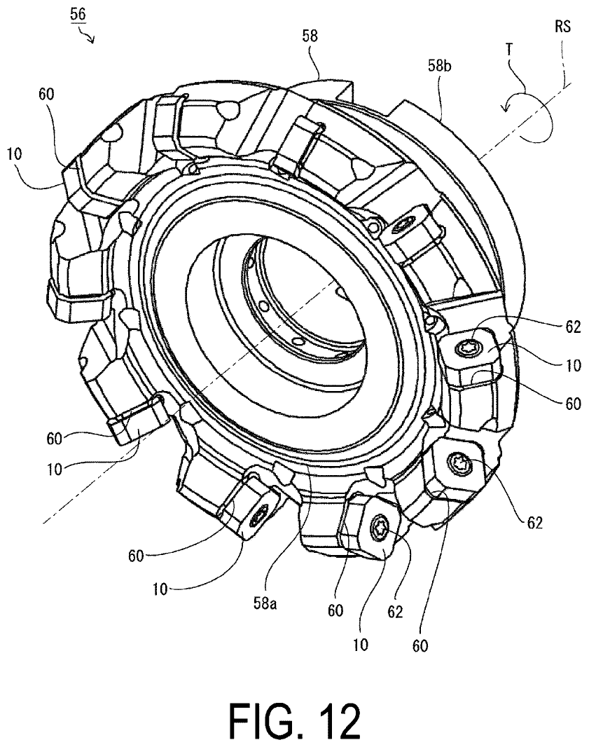

A cutting tool 56 according to the embodiment of the present disclosure will be described with reference to FIGS. 11 and 12. FIG. 11 is a schematic perspective view of the cutting tool 56 according to the embodiment of the present disclosure. FIG. 12 is a schematic perspective view of the cutting tool 56 illustrated in FIG. 11 viewed at a different angle.

As illustrated in the examples in FIGS. 11 to 12, the cutting tool 56 according to the embodiment of the present disclosure is a tool used for machining the workpiece W (see FIG. 13) and rotatable about a rotation axis RS. The cutting tool 56 may include a holder 58 attached to a main spindle of a processing machine such as a milling machine. The holder 58 may have a cylindrical shape extending from a front end 58a to a second end 58b along the rotation axis RS. Examples of the material of the holder 58 include metals, such as stainless steel, carbon steel, cast iron, and an aluminum alloy. A plurality of pockets 60 may be located at intervals in a peripheral direction on the outer peripheral surface of the holder 58. The plurality of pockets 60 may be located at equal intervals in the peripheral direction or at unequal intervals in the peripheral direction. The number of the pockets 60 may be one.

As in the examples illustrated in FIGS. 11 and 12, the cutting tool 56 may include the cutting insert 10 located in each of the pockets 60 of the holder 58. The cutting insert 10 may be located only in a selected one or more of the pockets 60 in the holder 58. The cutting insert 10 may be fixed to the pocket 60 of the holder 58 by a fixing screw 62 inserted in the mounting hole 18. The cutting insert 10 may be fixed to the pocket 60 of the holder 58 by a clamp member.

### Method for Manufacturing Machined Product

A method for manufacturing the machined product according to the embodiment of the present disclosure will be described with reference to FIGS. 13 to 15. FIGS. 13 to 15 are schematic views illustrating the method for manufacturing the machined product according to the embodiment of the present disclosure.

As illustrated in FIGS. 13 to 15, the method for manufacturing the machined product according to the embodiment of the present disclosure is a method for manufacturing M a machined product, which is the workpiece W after machined, and includes a first step, a second step, and a third step. The first step is a step of rotating the cutting tool 56. The second step is a step of bringing the cutting tool 56, which is rotating, into contact with the workpiece W. The third step is a step of separating the cutting tool 56 from the workpiece W. Here, examples of the material of the workpiece W include aluminum alloy, stainless steel, carbon steel, alloy steel, cast iron, and non-ferrous metal. The specific content of the method for manufacturing the machined product according to the embodiment of the present disclosure is as follows.

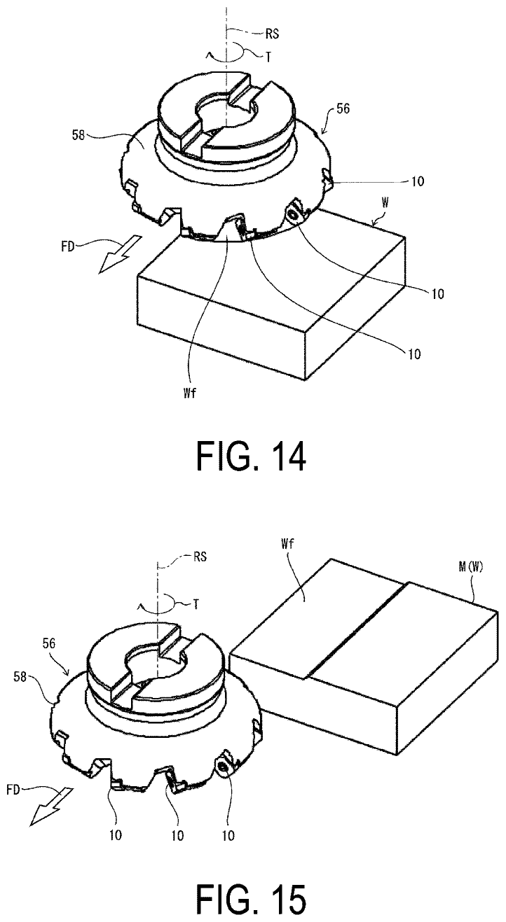

As in the examples illustrated in FIGS. 13 and 14, the cutting tool 56 is moved toward the workpiece W in the direction of an arrow FD while being rotated in a rotation direction T. Then, the cutting insert 10 of the cutting tool 56, which is rotating, is further moved in the direction of the arrow FD while being brought into contact with the workpiece W. Thus, machining of the workpiece W is performed by the cutting tool 56, and a machined surface Wf is formed on the workpiece as in the example illustrated in FIG. 15.

Subsequently, as in the example illustrated in FIG. 15, the cutting tool 56 is moved in the direction of the arrow FD to be separated from the workpiece W. This completes the machining of the workpiece W and enables the machined product M, which is the workpiece W after the machining, to be manufactured. Since the cutting tool 56 has excellent cutting capabilities because of the above reasons, the machined product M having an excellent machining accuracy can be manufactured.

When the machining is continued, the cutting insert 10 of the cutting tool 56 simply has to be repeatedly brought into contact with a different portion of the workpiece W while the cutting tool 56 is being rotated. Although the cutting tool 56 is brought close to the workpiece W in the embodiment of the present disclosure, the cutting tool 56 only needs to be brought relatively close to the workpiece W. Accordingly, for example, the workpiece W may be brought close to the cutting tool 56. In this respect, the same procedure is performed in separating the cutting tool 56 from the workpiece W.

In the present disclosure, the invention has been described above based on the drawings and embodiments. However, the invention according to the present disclosure is not limited to the above-described embodiment. In other words, the embodiment of the invention according to the present disclosure can be modified in various ways within the scope illustrated in the present disclosure, and embodiments obtained by appropriately combining the disclosed technical means are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

10 Cutting insert
12 Upper surface
14 Lower surface
16 Side surface
18 Mounting hole
20 Top cutting edge
22 Bottom cutting edge
24 First corner (corner portion)
26 Second corner (another corner portion)
28 First side (side portion)
28a First portion
28b Second portion
28c Third portion
30 Second side (another side portion)
32 Land portion
34 Outer inclined surface
34A First outer region
34B Second outer region
34C Third outer region
36 Middle inclined surface
36a First middle region
36b Second middle region
36c Third middle region
38 Inner inclined surface
38a First inner region
38b Second inner region
38c Third inner region
40 Minor inclined surface
42 First corner inclined surface
44 Second corner inclined surface
46 Bottom surface
48 Main cutting edge
50 Minor cutting edge
52 First corner edge
54 Second corner edge
56 Cutting tool
58 Holder
60 Pocket
62 Fixing screw
CS Insert central axis
PD Direction parallel to insert central axis
RS Rotation axis

1. A cutting insert, comprising:
an upper surface;
a lower surface located on an opposite side of the upper surface;
a side surface connected to the upper surface and the lower surface; and
a cutting edge located at an intersection of the upper surface and the side surface,
wherein the upper surface comprises
a corner portion,
a side portion connected to the corner portion and coming close to the lower surface with distance from the corner portion,
an outer inclined surface extending along the side portion and coming close to the lower surface with distance from the side portion,
a middle inclined surface extending along the outer inclined surface and coming close to the lower surface with distance from the outer inclined surface,
an inner inclined surface extending along the middle inclined surface and coming close to the lower surface with distance from the middle inclined surface, and
a flat bottom surface connected to the inner inclined surface,
in a cross-section taken along a parallel direction to an insert central axis passing through a center of the upper surface and a center of the lower surface, the outer inclined surface has a linear shape, and the middle inclined surface has a protruding curved shape protruding in an upward direction,
the side portion comprises
a first portion connected to the corner portion and
a second portion connected to the first portion,
the outer inclined surface comprises
a first outer region extending along the first portion and having a width in a direction orthogonal to the first portion decreasing with distance from the corner portion and
a second outer region extending along the second portion and having a width in a direction orthogonal to the second portion increasing with distance from the corner portion, and
the middle inclined surface comprises
a first middle region extending along the first outer region and having a width in the direction orthogonal to the first portion increasing with distance from the corner portion and a second middle region extending along the second outer region and having a width in the direction orthogonal to the second portion decreasing with distance from the corner portion.

2. The cutting insert according to claim 1,
wherein the middle inclined surface has an arc shape in the cross-section taken along the parallel direction, and
the first middle region has a radius of curvature in the cross-section taken along the parallel direction increasing with distance from the corner portion.

3. The cutting insert according to claim 2, wherein the second middle region has a radius of curvature in the cross-section taken along the parallel direction decreasing with distance from the corner portion.

4. The cutting insert according to claim 1, wherein the outer inclined surface has an inclination angle with respect to a direction orthogonal to the parallel direction decreasing with distance from the corner portion.

5. The cutting insert according to claim 1, wherein a length of the second portion is greater than a length of the first portion.

6. The cutting insert according to claim 1,
wherein the inner inclined surface comprises
a first inner region extending along the first middle region and having a width in a direction orthogonal to the first portion decreasing with distance from the corner portion and
a second inner region extending along the second middle region and having a width in a direction orthogonal to the second portion increasing with distance from the corner portion.

7. The cutting insert according to claim 1,
wherein the side portion further comprises a third portion connected to the second portion,
the outer inclined surface further comprises a third outer region extending along the third portion and having a width in a direction orthogonal to the third portion decreasing with distance from the corner portion, and
the middle inclined surface further comprises a third middle region extending along the third outer region and having a width in the direction orthogonal to the third portion increasing with distance from the corner portion.

8. The cutting insert according to claim 7,
wherein the middle inclined surface has an arc shape in the cross-section taken along the parallel direction, and
the third middle region has a radius of curvature in the cross-section taken along the parallel direction increasing with distance from the corner portion.

9. The cutting insert according to claim 7, wherein a length of the third portion is greater than a length of the first portion and a length of the second portion.

10. A cutting tool, comprising:
a holder having a cylindrical shape extending from a first end to a second end along the rotation axis and comprising a pocket located on a side of the first end; and
the cutting insert according to claim 1 located in the pocket.

11. A method for manufacturing a machined product, the method comprising:
rotating the cutting tool according to claim 10;
bringing the cutting tool rotating into contact with a workpiece; and
separating the cutting tool from the workpiece.
